(19) United States
(12) Patent Application Publication
(10) Pub. No.: US 2017/0349106 A1
(43) Pub. Date: Dec. 7, 2017

(54) DUAL WALL VEHICLE STORAGE SYSTEM

(71) Applicant: Penda Corporation, Portage, WI (US)

(72) Inventors: Jason D. Zajicek, Portage, WI (US); Vince Rocheleau, Metamora, MI (US); Thomas J. Harvey, Endeavor, WI (US); Thomas E. Klappstein, Portage, WI (US); Anthony C. Wangelin, DeForest, WI (US); Bradley Kerl, Dane, WI (US)

(21) Appl. No.: 15/253,004

(22) Filed: Aug. 31, 2016

Related U.S. Application Data
(60) Provisional application No. 62/345,426, filed on Jun. 3, 2016.

(51) Int. Cl. B60R 9/02; B60R 11/06

(52) U.S. Cl. CPC B60R 9/02; B60R 11/06

(57) ABSTRACT

A storage system for a pick-up truck is provided. The storage system includes a primary panel attachable to a sidewall of the truck and extending over a wheel well of the truck. A secondary panel is joined to the primary panel. The primary panel and secondary panel form a container therebetween having an opening which extends over the wheel well of the truck. A lid pivotably connects to either the primary panel or the secondary panel and covers the opening. At least one of the primary panel, the secondary panel and the lid is formed of twin sheet plastic material.

### CROSS-REFERENCE TO RELATED APPLICATIONS

This application claims the benefit of the disclosure of U. S. Provisional Patent Application No. 62/345,426, filed on Jun. 3, 2016, entitled “Dual Wall Truck Bed Liner,” the contents of which is incorporated herein by reference in its entirety.

### FIELD OF THE INVENTION

The inventions herein relate generally to storage containers or boxes, and more particularly to utility boxes or storage systems integrated with the cargo bed of a pick-up truck.

### BACKGROUND

Truck bed liners and spray-on liners for truck beds are known and used to protect the surfaces of the truck bed from scratches, dents, and other damage. These liners are typically made of a plastic material.

Tool or utility boxes designed for use in the beds of trucks, and specifically, pick-up trucks to store tools and other equipment are also known. These utility boxes typically include a bin and a lockable lid. Some such utility boxes include dividers, trays, and drawers to compartmentalize the storage area. Many of these storage containers span the width of the truck bed and are supported on the rails. Utility boxes and other storage accessories are also known which have various mechanisms for supporting themselves within a pick-up cargo bed. For example, the utility box can be supported on the bed side walls of a truck so that it is positioned above the floor of the cargo bed. Others are supported on legs to provide a space beneath the box. Some boxes are secured to the truck bed using bolts or anchors extending through truck bed walls. Many of these utility boxes are provided on the interior side walls of the truck bed, but such storage systems take up space within the truck bed, limiting the diverse use of the truck bed. In addition, these systems do not fully utilize the space as they are often installed forward or rearward of the truck's wheel well. In an attempt to solve the space concerns noted above, it is also known to provide storage compartments integrated into the side walls of a truck bed. These storage compartments are limited in size to the size of the truck bed sidewall and are accessible from the exterior of the bed (i.e., on the ground next to the truck). Unfortunately, these storage compartments must be created as part of the original engineering or manufacturing of the vehicle, increase the dimensions of the truck bed side walls, and consequently may also limit the size of the bed.

Accordingly, a need exists for a storage compartment which can be integrated into the truck bed, but which does not significantly impact the available space in the truck bed, and in particular the space between the wheel wells.

### SUMMARY

A storage system for a pick-up truck is disclosed as shown in the drawings and written description. The storage system includes a primary panel secured to an inside sidewall of the truck cargo bed and extending over a wheel well of the truck. A secondary panel is joined to the primary panel. The primary panel and secondary panel form a container therebetween having an opening which extends over the wheel well of the truck. A lid pivotably connects to either the primary panel or the secondary panel and covers the opening. At least one of the primary panel, secondary panel and lid are of dual wall plastic construction to provide strength and rigidity to the storage system.

Additionally, a storage container for use in the cargo bed of a pick-up truck is disclosed. The storage container has a bin defining a storage compartment. The bin includes an upper rim defining an opening into the storage compartment. The bin also includes a back wall, two side walls, a base and a front wall. A lid is pivotally secured to the bin so as to contact the upper rim and cover the opening into the storage compartment when the lid is in a closed position.

An alternative storage system for a truck is also disclosed. The storage system includes an upper storage container and a lid pivotable to open and close the upper storage container. A lower storage container is provided, seated below the upper storage container and having an access door which is movable to open and close the lower storage container.

These and other features and advantages of devices, systems, and methods according to this invention are described in, or are apparent from, the following detailed descriptions of various examples of embodiments and the drawings and illustrations thereof.

### BRIEF DESCRIPTION OF DRAWINGS

Various examples of embodiments of the systems, devices, and methods according to this invention will be described in detail, with reference to the following figures, wherein:

FIG. 1 is a partial perspective view of one or more examples of a vehicle having a storage system as described herein.

FIG. 2 is a cut-away perspective view of the vehicle shown in FIG. 1, showing an exemplary storage system as described herein, and having a lid of the storage system in a closed position.

FIG. 3 is a partial top plan view of the exemplary storage system shown in FIG. 2, taken from line 3-3 of FIG. 2.

FIG. 4 is a cut-away perspective view of the vehicle shown in FIG. 1, showing the storage system of FIG. 2, with the lid in an open position.

FIG. 5 is a partial top plan view of the storage system shown in FIG. 4, taken from line 5-5 of FIG. 4.

FIG. 6 is a partial exploded view of a primary panel for use with the storage system shown in FIG. 2.

FIG. 7 is a partial exploded view of the primary panel shown in FIG. 6, taken from the opposing side of said panel.

FIG. 8 is an exploded view, showing the primary and secondary panels of the storage system of FIG. 2.

FIG. 9 is a perspective view of the secondary panel shown in FIG. 8, showing the opposing side of the secondary panel.

FIG. 10 is a partial exploded perspective view, showing the lid-primary panel, secondary panel, and primary panel of the storage system shown in FIG. 2.

FIG. 11 is a partial exploded perspective view of a lid sub-assembly for use with the storage system shown in FIG. 2, showing the hinge and lid-primary panel.

FIG. 12 is a partial exploded perspective view of a lid sub-assembly for use with the storage system of FIG. 2, showing the weather strip and lock sub-assembly.

FIG. 13 is a cut-away partial exploded perspective view of a lock sub-assembly for use with the lid sub-assembly with the storage system shown in FIG. 2.

FIG. 14 is an exploded perspective view of the latch bracket sub-assembly for use with the lock sub-assembly and storage system.

FIG. 15 is a partial perspective view of the storage system shown in FIG. 2, showing an access door according to one or more examples of embodiments.

FIG. 16 is a perspective view of the access door shown in FIG. 15 for use with the storage system of FIG. 2.

FIG. 17 is a partial exploded perspective view of the storage system shown in FIG. 2, showing an outlet shroud according to one or more examples of embodiments.

FIG. 18 is a partial perspective view of one or more alternative examples of a vehicle having an alternative example of a storage system.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

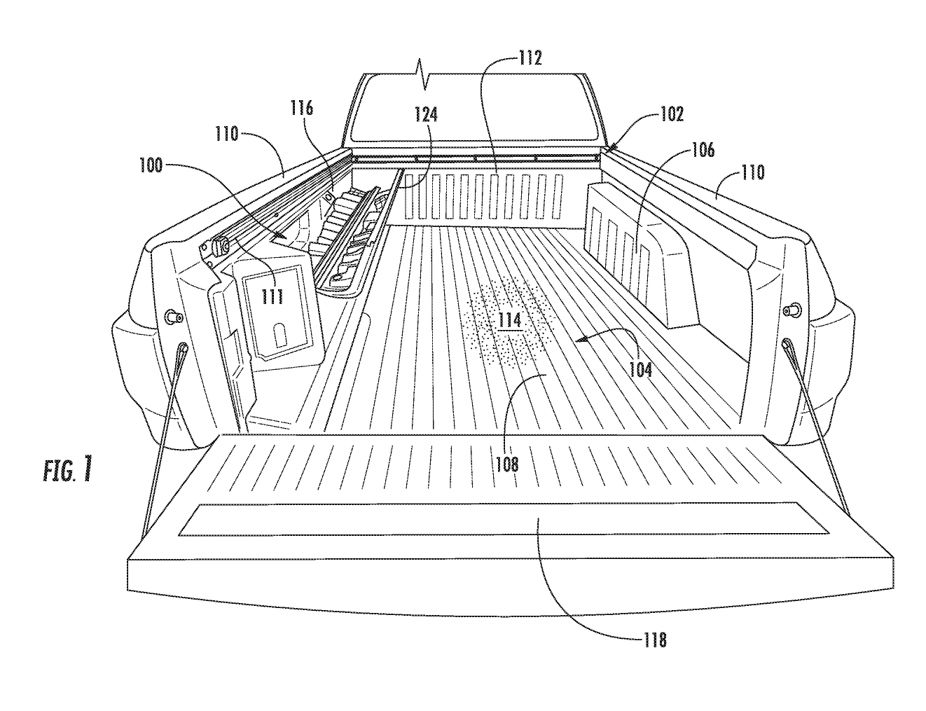

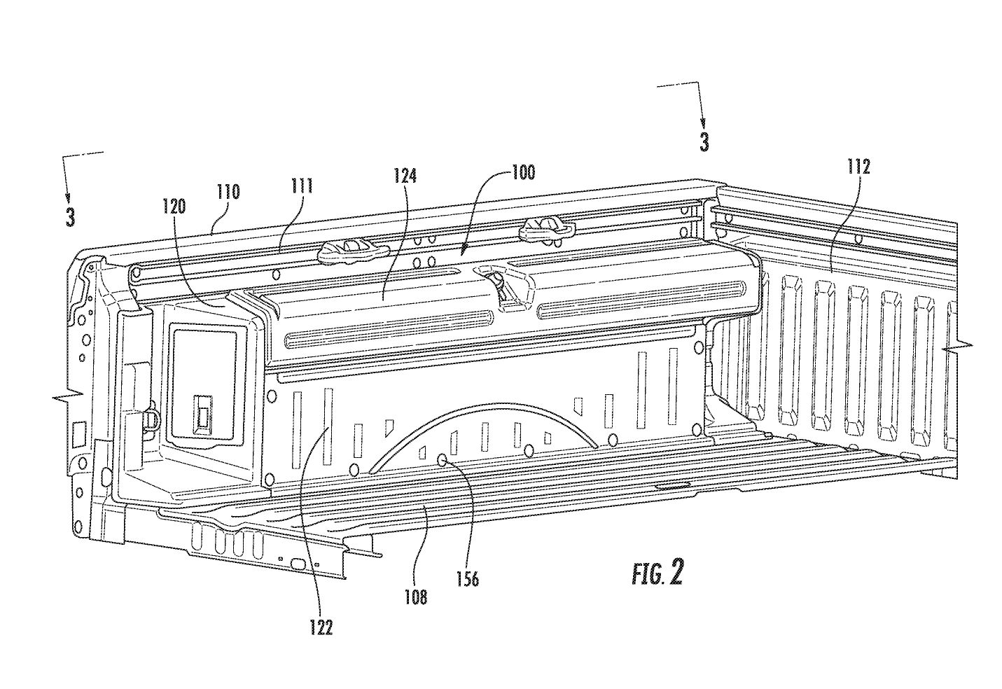

As illustrated in the Figures, a storage container 100 or storage system is provided which, in the arrangement shown in the Figures, is designed for use in one or more examples as a utility box for a vehicle. More specifically, the storage container 100 is for use with a truck 102, such as a pick-up truck (see FIGS. 1-2). The storage container 100 may be mounted in the cargo bed 104 of a pick-up truck 102, and in particular along the sidewall or rail and over the wheel well 106 of the truck bed 104.

In the illustrated embodiment, the truck cargo bed 104 is standard and its construction is known to those skilled in the art. Briefly, as shown in FIG. 1, the cargo bed 104 includes a bottom wall or floor 108, opposite side walls 110 that include wheel well portions 106, and a front wall 112. The cargo bed 104 may be provided with a bed liner, such as a known “drop-in” under-the-rail plastic bed liner. However, it is also contemplated that the storage container 100 may be provided or used without a bed liner, or alternatively may be used with an alternative liner type, such as a conventional spray-in liner 114, schematically shown in FIG. 1 by stippling in the area of the reference number 114.

As shown in FIGS. 1-5, the storage container 100 includes a container portion or bin that defines a storage compartment with an interior 116 for stowing tools, equipment, material, etc. Preferably, the panels and doors/lid of the storage compartment (described in more detail below) are formed of a material that is durable and water resistant, and more preferably of a material having higher dimensional stability and impact resistant characteristics, such as but not limited to thermoplastic polyolefins. In one or more examples of embodiments, the storage container 100 is preferably formed of panels of twin sheet thermoformed plastic or polymeric material, with each panel having a unitary construction. It is also contemplated that the storage container 100 can be so formed from sheets of thermoplastic material, such as high density polyethylene. Such plastic panels can also be formed by blow-molding, wherein the panels are formed by a different known process, but the resulting integral plastic panel consists of a unitary closed dual sheet structure as generally shown and described herein. Any such construction as described above is referred to herein as “dual wall” construction. In one or more embodiments, the material has a high density polyethylene surface, which can correspond to the headwall, floor, and/or tailgate liner material used. The panels and doors/lid (described in further detail below) can optionally be further insulated, such as by the inclusion of foam or other insulating material within the formed dual wall panels and/or lid.

The storage container 100, in one or more examples of embodiments, is shown as provided or used in an area (or areas if two such containers are provided) covering or overlapping the wheel well(s) 106 in the bed 104 of the truck 102. However, it is contemplated that storage containers may be provided for use with the headwall or front wall 112, floor 108 and/or tailgate 118. The storage container 100 design is adaptable to any specific bed design and bed length. While the container 100 may be installed during manufacture of the vehicle, it is preferably an aftermarket part which is installed post manufacture. The storage container 100 preferably substantially maintains the standard bed width of the truck bed 104, and in particular the distance between the wheel wells 106, and integrates with standard and optional bed features.

Referring to FIGS. 2-5, the storage container 100 is formed generally of a primary panel 120, a secondary panel 122 joined to the primary panel, and a lid 124. The respective panels may be separately formed and secured together by suitable fasteners (including but not limited to threaded fasteners such as screws) or alternatively each can be integrally formed as one or more units by use of twin sheet thermoforming or blow-molding equipment, methods and techniques, or other known plastic forming processes as previously described.

Additional accessories may be provided which are coupled to or integral with the storage container 100. For example, a frame and access panel sub-assembly 128 may be provided which provides additional storage or alternatively, provides a structure surrounding or covering an electrical outlet (not shown). The frame 130 can be formed from or integral with the primary panel 120. Additionally, as can be seen in the Figures, one or more tie downs 132 or loops may be provided in the storage container 100 or alternatively apertures may be provided in the primary panel 120 such that tie downs 132 such as loops or other structure provided on the truck bed 104 extend through apertures in the panel, e.g., panel 120. One or more open storage bins with netting partially or completely forming one or more walls (not shown) for retention of stored articles may also be used in one or more examples of embodiments.

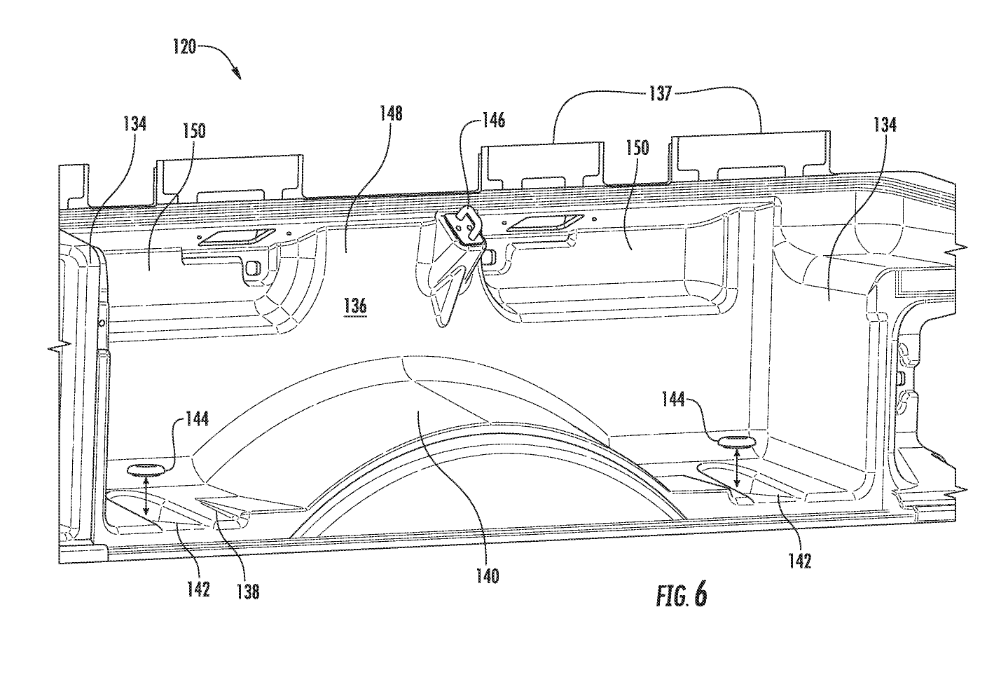

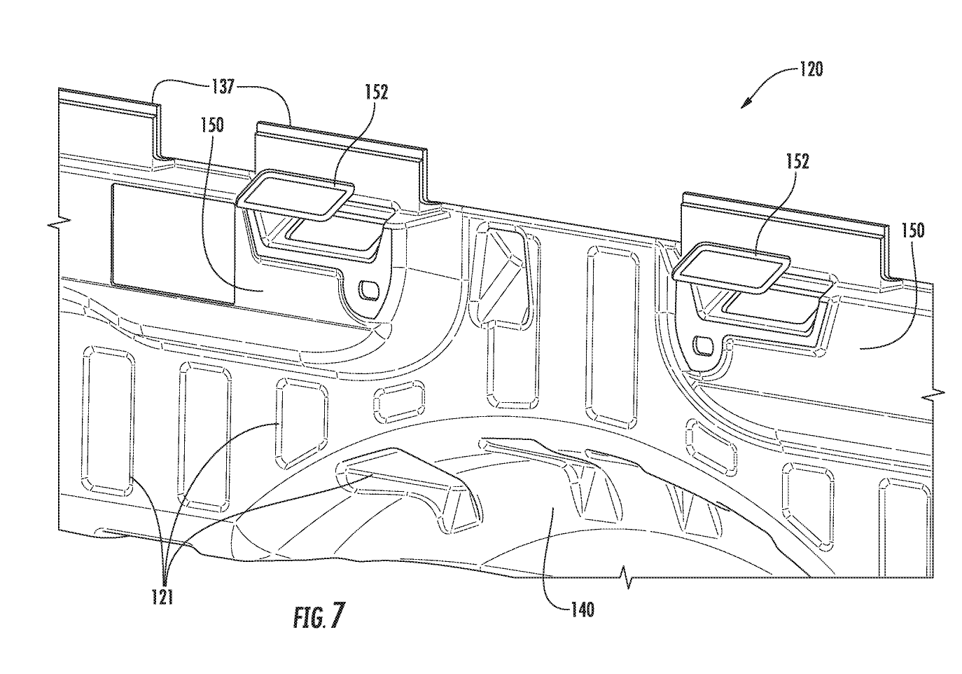

Referring to FIGS. 6-7, the exemplary primary dual wall panel 120 is shaped to conform with the contours of a truck sidewall and bed 104. The primary panel 120 has a structure defining a pair of side walls 134, a back wall 136, and a base 138 of the container 100. The back wall 136 and base 138 of the primary panel 120 include an upwardly arcuate portion 140, or wheel well clearance area which corresponds to the wheel well 106 of the vehicle. In this regard, the base 138 may rest on the truck bed floor 108 along the side walls 110 of the truck, with the upwardly arcuate portion 140 accounting for the variation in truck bed 104 dimension. The base 138 may also include one or more drains 142 and drain plugs 144. A portion 146 of a lock assembly is secured to an upper area 148 of the primary panel 120. However, it is contemplated that said portion 146 of the lock assembly may also, or alternatively, be provided on the secondary panel 122. The backwall 136 is also shown in FIGS. 6-7 to have a plurality of spaced locking flanges 137 which extend upwardly therefrom for engagement by a retaining rail(s) 111 fastened to the sidewalls 110 of the truck cargo bed 104. The retaining rail(s) 111, best shown in FIG. 104, secure the overlapped locking flanges 137 against the truck sidewall 110 to thereby secure the storage container 100 in position along the sidewall as the storage container is further supported by the floor 108 and/or wheel well housing 106 of the truck cargo bed 104.

It can be observed from FIGS. 6-7 that the mating inside sheet of the dual wall, twin-sheet primary panel 120 shown in FIG. 6, and outside sheet of primary panel 120 shown in FIG. 7, have different contours, with the outside surface of FIG. 7 in particular showing various depressed areas 121. Such depressed areas 121, which may be in the form of shallow depressions or ribs, as shown, together with the margins and other engineered contact portions of the two sheets are fused together during pressure forming of the twin-sheet primary panel to form an integral, generally rigid structural panel 120, as known to persons skilled in the twin sheet thermoforming arts and shown in FIGS. 6 and 7.

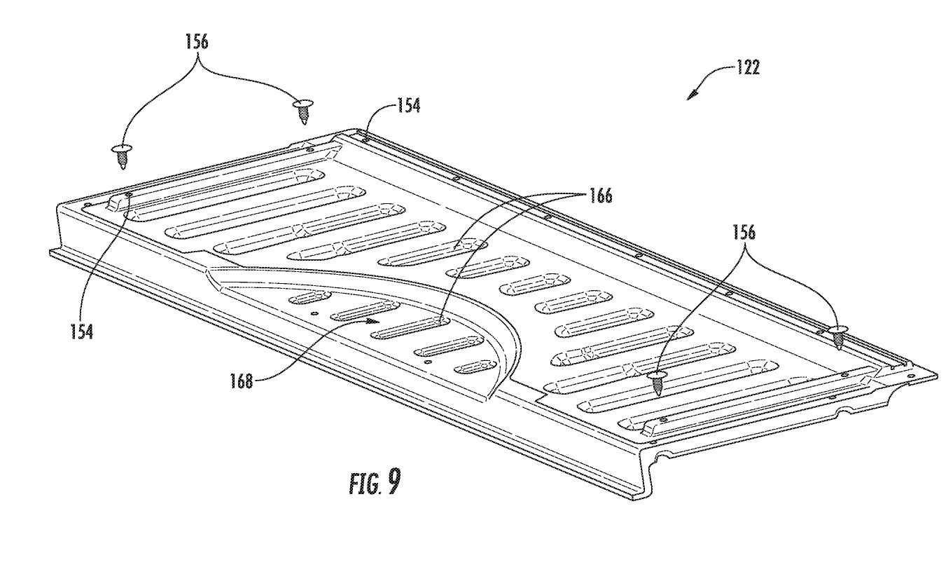

The primary panel 120 also includes one or more widened clearance areas 150 and one or more lights or windows or lenses 152 useable to provide light to the interior 116 of the bin. In one exemplary embodiment, the lenses 152 permit natural light or light from the vehicle lighting system to enter the interior 116 of the bin. In the alternative, lights, such as but not limited to LED lights, may also be provided. The primary panel also has various attachment apertures 154, permitting an attachment device or fastener 156, such as shown in FIG. 9, to extend through the panels and into a portion of the vehicle 102 for securing the primary and secondary panels together.

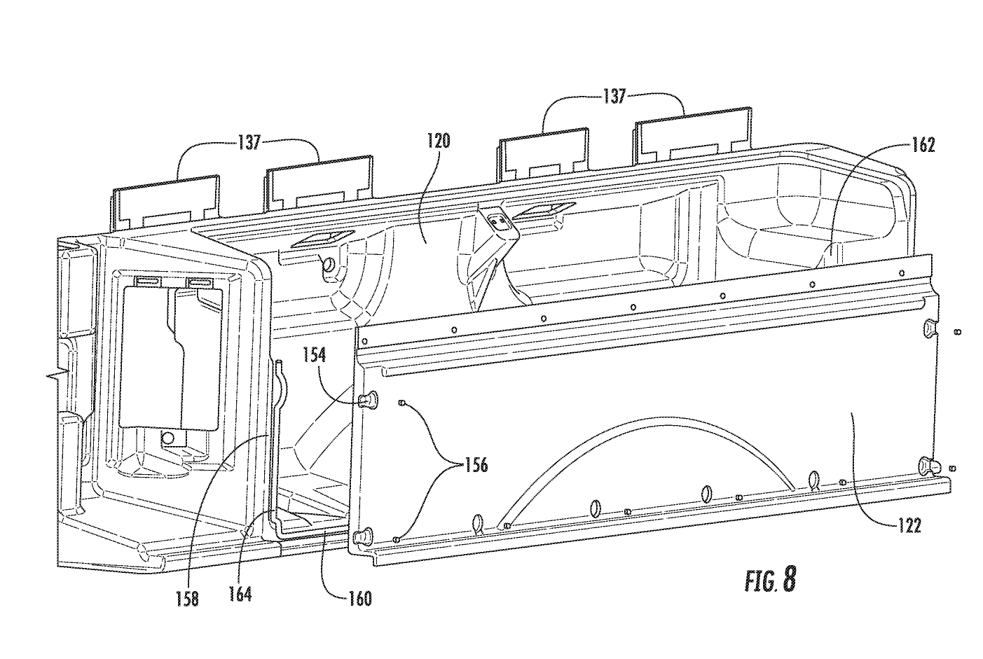

Referring further to FIGS. 8-9, the secondary panel 122 is secured to the primary panel 120 at one or more panel wall edges 158, 160, 162 formed at the edges of the side walls 134 and base 138 of the primary panel 120. In the illustrated example, a seal 164 or sealant is provided between the panels 120 and 122. In one or more examples of embodiments, adhesive, e.g., mastic, may also be used to seal the primary panel 120 and secondary panel 122 together, to further assist in forming a water tight seal. The secondary panel 122 is secured to the panel wall edges 158, 160, 162 by one or more fasteners 156, such as ringed or threaded fasteners or screws. The outside sheet of the secondary panel 122 may have a plurality of ridges and/or recesses or corrugations 166 on one or more surfaces, as best shown in FIG. 9. The ridges, recesses, corrugations and mating edges and surfaces of the panel 122 are typically pressure fused within the twin-sheet panel 122 to the opposing sheet at their contact areas by die pressure during pressure forming so as to provide integral structural rigidity for the panel 122. In the illustrated embodiment, the height of the secondary panel 122 is shorter than the height of the primary panel 120, consequently permitting easy access to the interior 116 of the bin. In the embodiment shown in FIG. 9, the secondary panel 122 also includes a wheel well recess 168 which is shaped to mate with the corresponding upwardly arcuate wheel well clearance area 140 of the primary panel 120. The wheel well recess 168 provides a close fit or flush mounting of the secondary panel 122 with the outer edge of the wheel well 106 (i.e., the innermost edge of the wheel well in the truck bed).

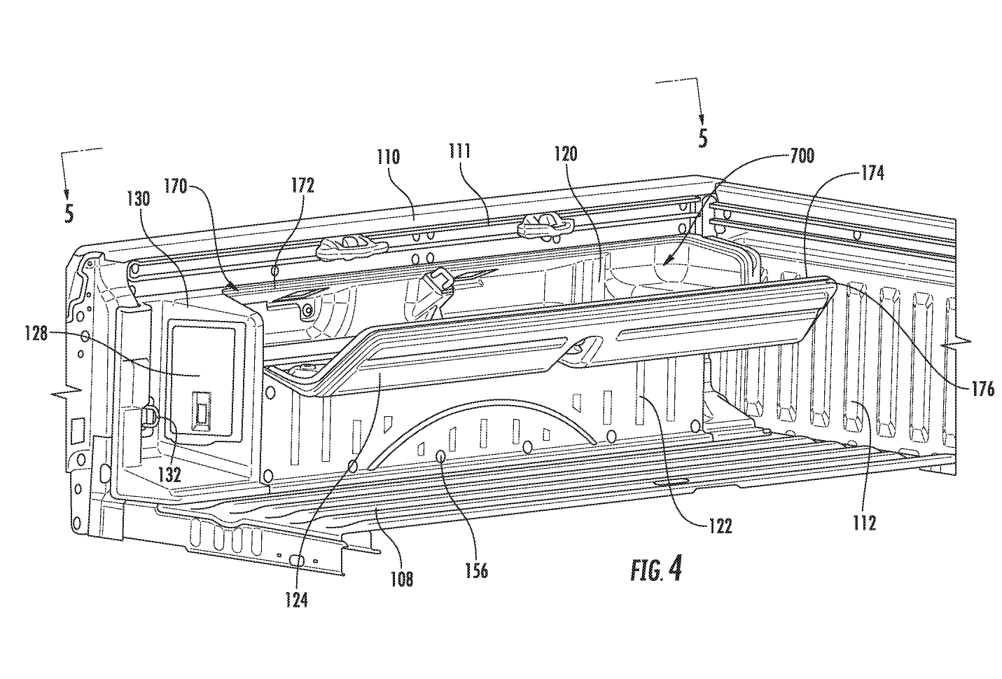

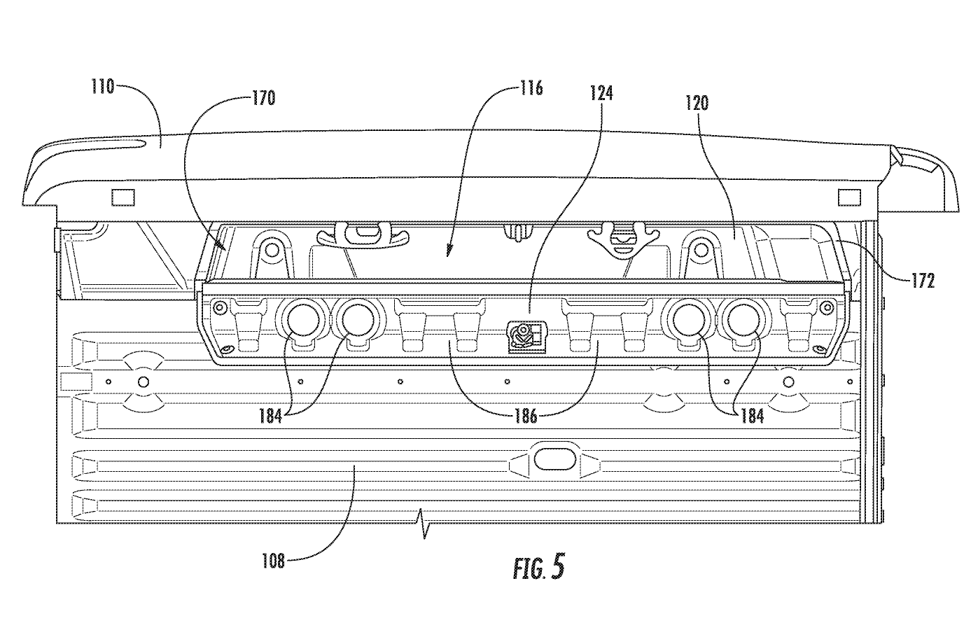

Referring again to FIGS. 4-5, the primary panel 120 of the bin or container 100 includes an upper annular rim 170 that defines the opening through which access to the storage compartment is obtained. The upper rim 170 includes an annular seal surface 172 which in the illustrated arrangement is molded integrally with the rest of the bin. The seal surface 172 is engageable by a sealing gasket 174 along its periphery (see gasket 174 shown secured to lid 124 in FIG. 4). More particularly, a full perimeter gasket 174 co-extensive with the length of the seal surface 172 is provided so as to help maintain a water tight compartment when the lid 124 is closed.

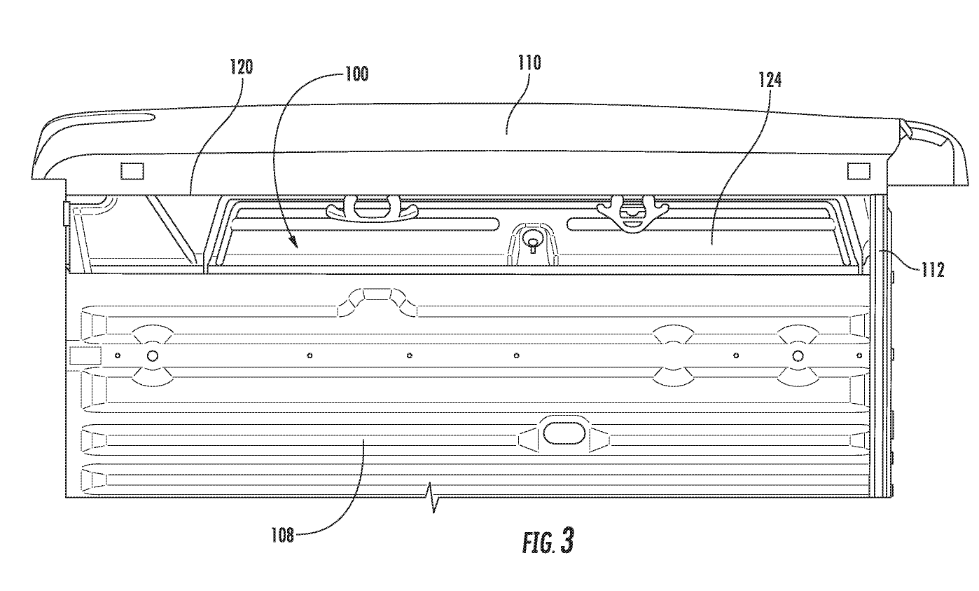

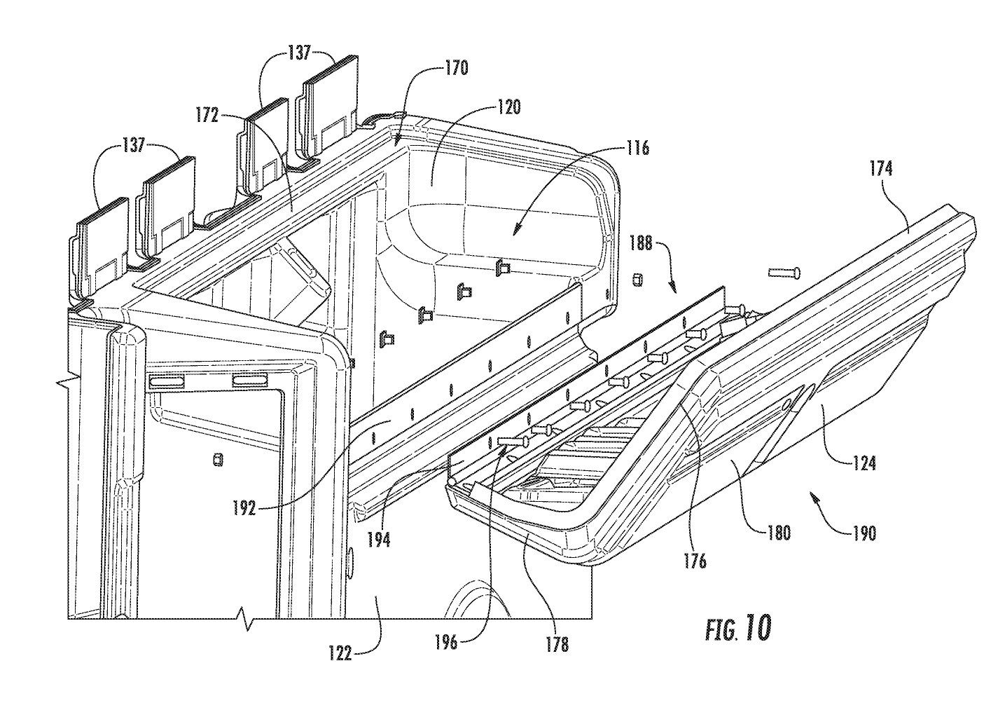

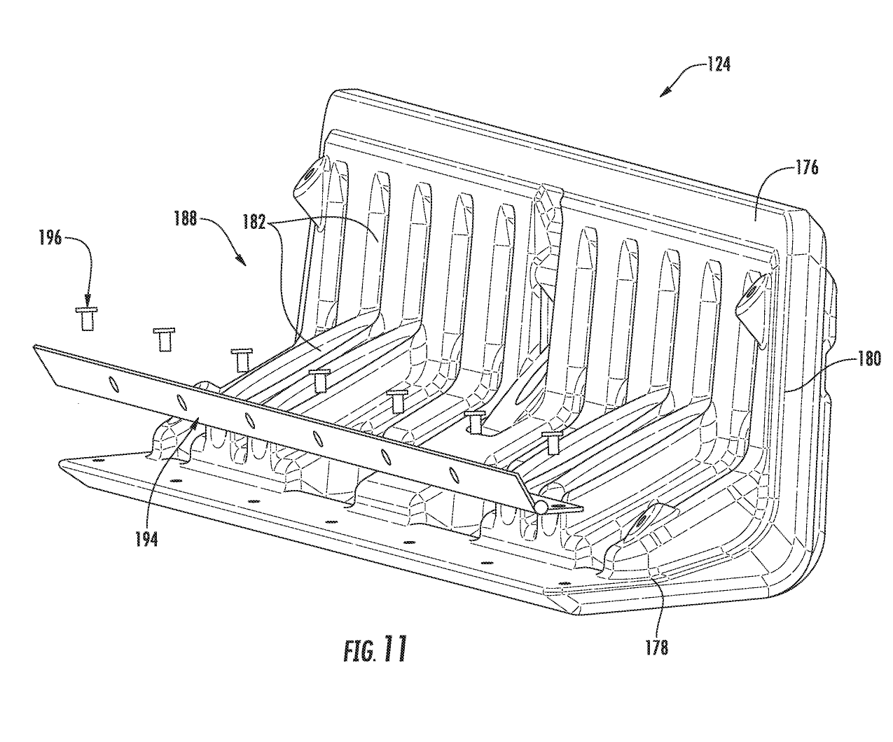

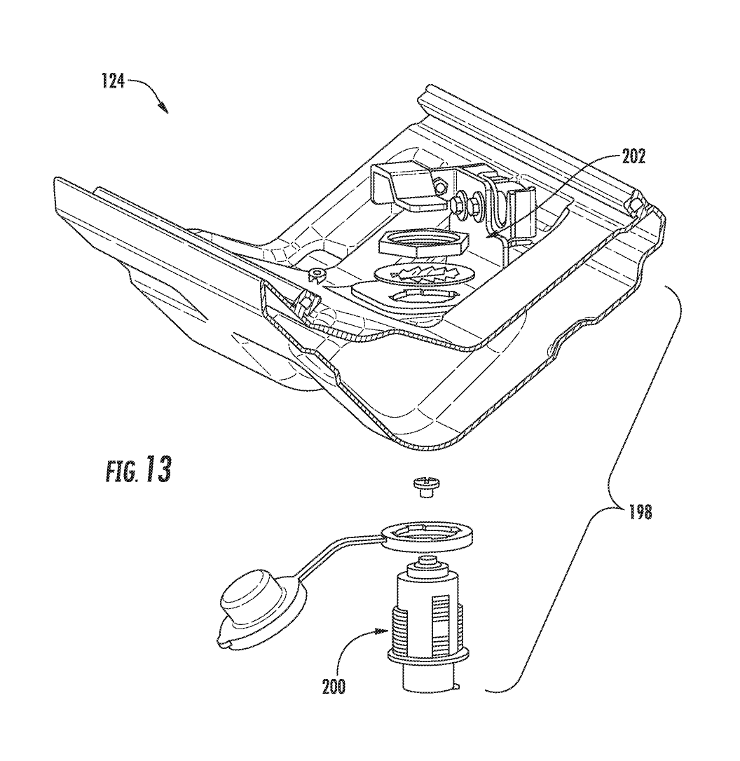

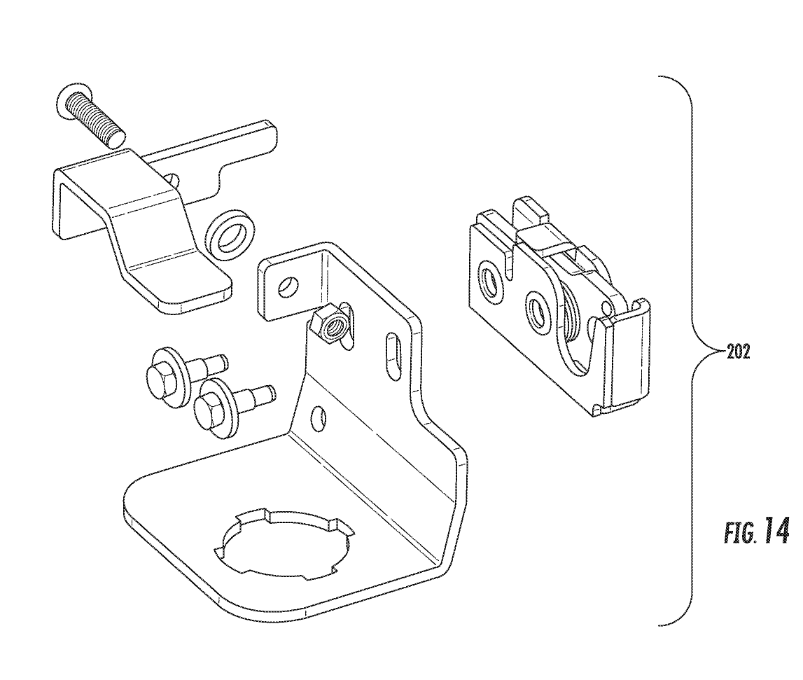

As indicated, the storage container 100 also includes a lid 124. Referring to FIGS. 10-14, a lid 124 is provided which is hingedly or pivotably coupled to the container 100. As shown in FIGS. 2-5 & 10, the lid 124 is pivotally mounted on the bin 100 for movement between a closed position (shown in FIGS. 2-3) and an open position (shown in FIGS. 4-5). More specifically, the lid 124 is pivotally mounted on the front wall (i.e., the secondary panel 122) of the storage container 100. As indicated, to prevent leakage between the lid 124 and the bin, the lid 124 may include a sealing surface 176 which engages the gasket 174 and the corresponding sealing surface 172 and overlies the sealing surface 172 of the upper rim 170 on the container 100 when the lid 124 is closed.

The lid 124 has a curved or angled shape. To this end, the lid 124 has a first segment 178 and a second segment 180. The second segment 180 is provided at an angle to the first segment 178. Preferably, the angle between the first and second segments 178, 180 is an angle other than 180 degrees, e.g., an angle less than 180 degrees, and in one example preferably approximately 90 degrees. As a result, when in the closed position (shown in FIG. 2) the lid 124 has a substantially vertical portion which accounts for the height difference between the secondary panel 122 and the primary panel 120, and the lid 124 has a substantially horizontal portion which covers the opening in the container.

The dual wall lid 124 also may have one or more ribs 182, or other structure which provides added structural rigidity to the lid 124 when the two sheets thereof are fused together during the forming operation as previously described with respect to the primary panel 120 and the secondary panel 122. As can be seen in FIG. 5, the lid 124 may also have additional structural features, such as one or more cup or beverage holders 184 and/or one or more containment areas 186. In the illustrated embodiment, these cup holders 184 and containment areas 186 are provided on the interior sheet or side 188 of the lid 124, but the cup holders 184 and/or containment areas 186 may also, or alternatively, be provided on the exterior sheet or side 190 of the lid 124, which may be generally planar or have longitudinal inverse ribs, as best shown in FIG. 2. Typically, in an exemplary embodiment, the valleys of the ribs 182 of the interior side 188 of the lid 124 will run at angles to the inverse ribs of the exterior side 190, and the two sides will be fused together in the forming operation between the ribs and at other junction points at the margins and engineered interior junction points to provided rigidity and strength to the lid 124.

In the illustrated example, the lid 124 is hingedly connected to a top portion 192 of the secondary panel 122. However, the lid 124 may be otherwise connected to the primary panel 120 or another structure without departing from the overall scope of the present invention. In the illustrated example, the lid 124 is pivotally mounted to the front wall or secondary panel 122 with a fixed hinge 194. More specifically, the lid 124 is secured to one “wing” of a hinge 194. A second wing of the hinge 194 is also secured to the secondary panel 122. In one or more examples of embodiments, the hinge 194 is secured to the lid 124 and panel by one or more ringed or threaded fasteners 196. However, variations thereon may be suitable for the purposes provided. The hinge 194 illustrated in the Figures is a common “piano” type hinge, but alternative hinges, more than one hinge, and other various means of pivotably securing the components together may be acceptable. As a non-limiting example, the secondary panel 122 and lid 124 may be joined by a “living” flexible plastic hinge integral or connected to the secondary panel 122 and the lid 124. The lid 124 is connected such that it opens by rotating into or toward the center of the truck bed 104. As indicated, the lid 124, optionally, includes a seal or gasket surrounding an outer edge of the lid 124, useful for preventing water and other environmental elements from entering the closed container 100.

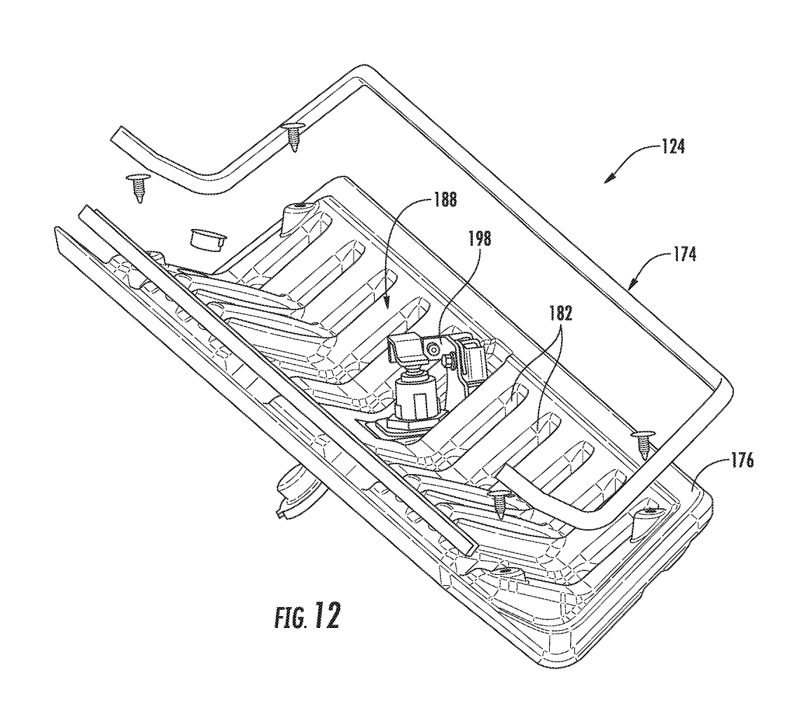

The lid 124 also includes a lock sub-assembly 198. The lock sub-assembly 198 includes a locking mechanism 200 and a corresponding latch bracket assembly 202. The latch bracket assembly 202 is secured to the lid 124 and holds the locking mechanism 200. As shown in FIGS. 12-14, a latch mechanism may be provided for locking and unlocking the lid 124. In one or more examples of embodiments, a programmable lock may be provided which may be keyed to match the vehicle key. Any conventional lock and latching mechanism may be provided as required.

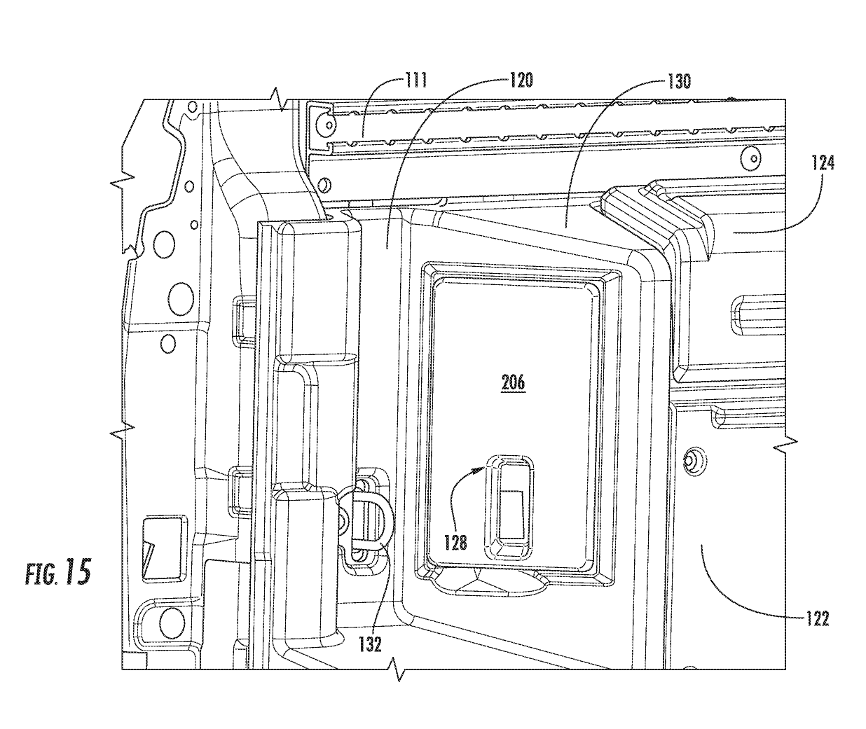

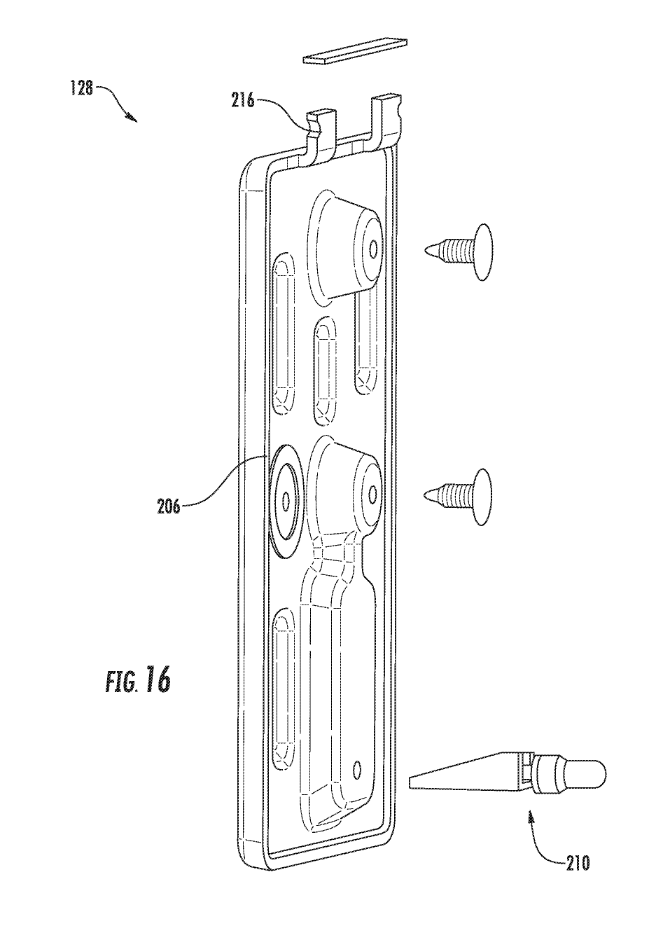

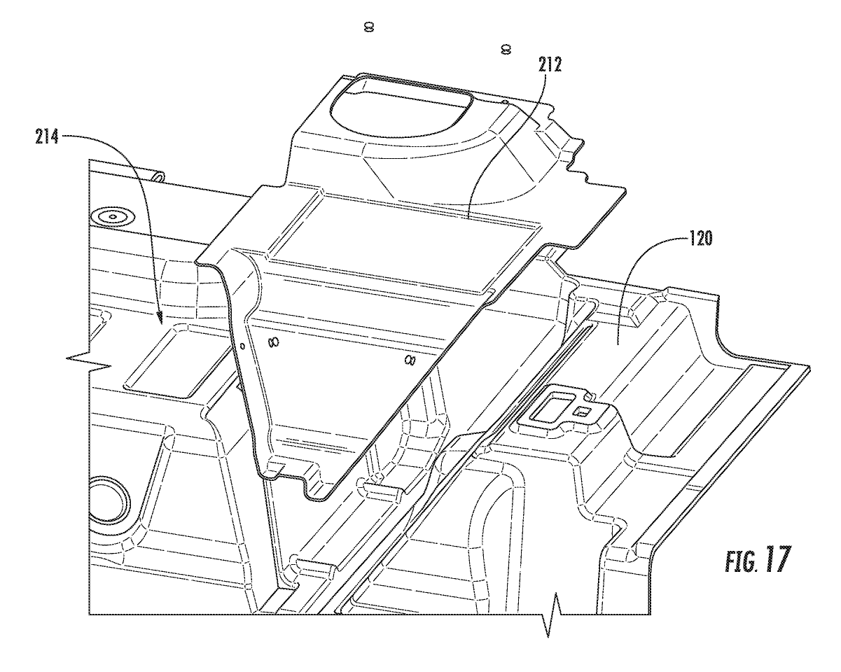

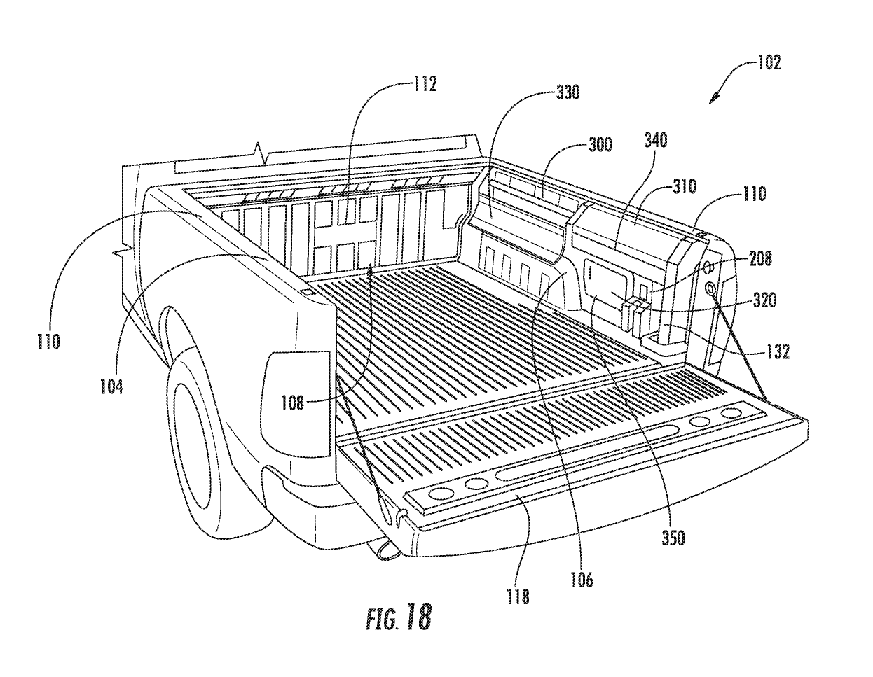

Referring to FIGS. 15-16, an access door 206 is provided in a frame portion 130 of the primary panel 120. The combination of access door 206 and frame portion 130 provides an area of additional storage and/or provides a cover for an outlet or the like. In this regard, this accessory accommodates vehicle power outlets. In other words, an electrical outlet may be provided behind the access door 206 or at any convenient location accessible within or through the storage container 100. As can be seen in FIG. 17, an outlet shroud 212 is provided on the back surface 214 of the primary panel 120. (The storage container 100 may also, optionally, be provided with a DC/AC power inverter 208, as in the alternate embodiment of FIG. 18). The access door 206 is provided with a latch 210 that may be hand-operable and secures the access door 206 in place on the frame portion 130. The access door 206 may also have one or more retaining protrusions or extensions 216 which engage a portion of the frame 130 or primary panel 120 on an end of the access door 206. The latch 210 may receive and cooperate with a programmable key.

Referring to FIG. 18, an alternative example of embodiments is provided in which a plurality of storage bins 300, 310, 320 are provided in the storage container. In the illustrated example, an overwheel storage bin 300 is provided adjacent to an upper storage bin 310 and lower storage bin 320. The upper storage bin 310 and overwheel storage bin 300 have hinged lids, 330, 340, respectively, while the lower storage bin 320 is provided with an access panel 350. Other features as previously described herein are also shown and may be otherwise added to the assembly shown in FIG. 18.

One or more examples of assembly of the storage container 100 will now be described in reference to the drawings. The panels and various accessories of the storage container 100 may be assembled together and then placed into the vehicle bed 104, or alternatively may be installed directly or individually in the vehicle bed 104. The primary panel 120 is placed along the sidewall and over the wheel well 106 of the truck bed 104. The primary panel 120 may be attached to the sidewall of the truck bed 104 by any suitable means, including the previously described backwall locking flanges 137 secured to the truck sidewall by retaining rail 111. The secondary panel 122 is secured to the primary panel 120 using the mechanisms described above. The lid 124 may be secured to the secondary panel 122 with a hinge 194. Various additional accessories may be added to the primary panel 120 as described herein, such as but not limited to, the outlet shroud and access door 206.

Once installed, a user may access the interior of the storage container 100 or bin by pivoting or rotating the lid 124 about its hinge 194 from the closed position (FIG. 2) to the open position (FIG. 4). If a lock assembly is installed, the user may key open the lock prior to opening the lid 124. Once the lid 124 is open, the user may access the interior to store or retrieve items, and then subsequently close the lid 124.

Advantageously, the storage container described herein is integrated into the truck bed, but does not significantly impact the available space in the truck bed, and in particular the space between the truck wheel wells 106. As a result, for example, standard sheets of plywood will still fit flat between wheel wells. Moreover, the storage container is easy to install and remove, and does not require damage to the truck bed as a drill is not required for installation. The storage container is also water tight, protecting the contents from the environment and allowing users to use the container like a cooler. The storage container may include lenses and/or lighting, increasing visibility within the container. The storage container is also adaptable for use with a vehicle on which it is installed, accommodating vehicle lighting and power outlet(s), and providing programmable locks to match the vehicle key.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that functional insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, particularly to accommodate the manufactured dimensions of any past or future marketed truck bed, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

The technical effects and technical problems in the specification are exemplary and are not limiting. It should be noted that the embodiments described in the specification may have other technical effects and can solve other technical problems.

1. A storage system for a pick-up truck comprising:
a primary panel attachable to a sidewall of the truck and extending over a wheel well of the truck;
a secondary panel joined to the primary panel, the primary panel and secondary panel forming a container therebetween having an upper opening; and
a lid pivotably connected to either the primary panel or the secondary panel and covering the upper opening; and
wherein at least one of the primary panel, the secondary panel and the lid are of formed dual wall plastic material.

2. The storage system of claim 1, wherein the primary panel, the secondary panel, and the lid are formed of twin sheet thermoformed plastic material.

3. The storage system of claim 1, wherein the primary panel is attachable to the sidewall of the pick-up truck bed.

4. The storage system of claim 1, wherein the primary panel has a back wall, first and second side walls, and a base, wherein the secondary panel is joined to the first and second side walls and the base.

5. The storage system of claim 1, wherein the primary panel has an adjoining outlet shroud.

6. The storage system of claim 5, wherein the outlet shroud is formed in part by one of the first and second side walls.

7. The storage system of claim 5, wherein the outlet shroud includes an access door.

8. The storage system of claim 1, wherein the lid comprises a first segment and a second segment, wherein the second segment extends at an angle other than 180 degrees from the first segment and extends to the wall opposite from its attachment, whereby the lid forms a cover for the storage system.

9. The storage system of claim 8, wherein the lid further comprises a cup holder.

10. The storage system of claim 8, wherein the lid further comprises a containment area.

11. The storage system of claim 1, wherein the container includes a drain.

12. The storage system of claim 1, wherein the primary panel includes a storage compartment adjacent to the container.

13. The storage system of claim 1, further comprising a lens for directing light within the container.

14. The storage system of claim 1, wherein the lid is pivotably connected to the secondary panel and is lockable with the primary panel.

15. The storage system of claim 1, wherein the primary panel provides access openings to truck tie down structure.

16. A dual wall plastic storage container for use in the cargo bed of a pick-up truck, the storage container comprising:
a bin defining a storage compartment, the bin including an upper rim defining an opening into the storage compartment, the bin including a back wall, two side walls, a base and a front wall; and
a lid pivotally secured to the bin so as to contact the upper rim and cover the opening into the storage compartment when the lid is in a closed position.

17. The storage container of claim 16, further comprising an adjacent side storage container integrally formed with the bin.

18. The storage container of claim 16, further comprising an outlet cover integrally formed with a portion of the bin.

19. A storage system for a pick-up truck comprising:
an upper dual wall storage container attachable to the bed of the truck and having a lid pivotable to open and close the upper storage container;
a lower storage container connected to and positioned below the upper storage container and having an access door which is movable to open and close the lower storage container.

20. The storage system of claim 19, further comprising an additional upper dual wall storage container, the additional upper storage container being attachable to and seated above the wheel well of the truck and having a lid pivotable to open and close the additional upper storage container.
